(19) United States
(12) Patent Application Publication
(10) Pub. No.: US 2002/0170237 A1
(43) Pub. Date: Nov. 21, 2002

(54) Polishing slurry for the chemical-mechanical polishing of silica films

(76) Inventors: Kristina Vogt, Koln (DE); Lothar Puppe, Burscheid (DE); Chun-Kuo Min, Taipei (TW); Li-Mei Chen, Hsinchu (TW); Hsin-Hsen Lu, Hsinchu (TW)

Correspondence Address: BAYER CORPORATION, PATENT DEPARTMENT, 100 BAYER ROAD, PITTSBURGH, PA, 15205, US

(21) Appl. No.: 10/023,172

(22) Filed: Dec. 17, 2001

(30) Foreign Application Priority Data
Dec. 20, 2000 (DE) 10063488.5

(51) Int. Cl. C09G 1/02; C09G 1/04; C09K 3/14

(52) U.S. Cl. 51/308; 106/3

(57) ABSTRACT

A polishing slurry for chemical-mechanical polishing, containing 5 to 50% by weight of a colloidal silica abrasive, and from about 0.1 to about 10% by weight of a quaternary ammonium salt which is represented by the formula R₄N⁺X⁻, where R may be identical or different and is selected from the group consisting of alkyl, alkenyl, alkylaryl, arylalkyl and an ester group, and X is hydroxyl or halogen, is distinguished by a high polishing rate.

### BACKGROUND

The present invention relates to a polishing slurry for chemical-mechanical polishing, which can be used to polish silica films, and in particular to a colloidal polishing slurry of the silica type which contains a quaternary ammonium salt.

Nowadays, chemical-mechanical polishing (CMP) is a preferred method in the fabrication of integrated circuits (ICs) in order to achieve global planarization on wafers. A wafer is a polished disc of silicon on which integrated circuits are constructed. First of all, a polishing slurry is applied to an elastomeric polishing pad or directly to the wafer surface which is to be polished. The polishing pad is then pressed against the surface which is to be polished and, in the process, is moved relative to the wafer plane, so that the particles of the slurry are pressed onto the wafer surface. The movement of the polishing pad causes the polishing slurry to be distributed and therefore causes the particles on the wafer surface to be distributed, leading to chemical and mechanical removal of the substrate surface.

Polishing slurries can be divided into two categories. One category comprises a suspension of pyrogenic silica as abrasive, and the other category contains colloidal silica as abrasive. The methods for preparing the polishing slurries from pyrogenic silica and from colloidal silica, also known as silica sol, are different. The suspension of pyrogenic silica is obtained by dispersing pyrogenic silica in an aqueous medium. For polishing slurries which contain colloidal silica, the colloidal silica is produced directly, by means of the sol-gel technique, from an aqueous solution, e.g. from a sodium silicate solution. At no time during production is the colloidal silica in a dry state which may lead to agglomeration or aggregation, as is the case with the pyrogenic silica. The suspension of pyrogenic silica has a wider particle size distribution than the polishing slurry from the colloidal silica category. This leads to the particles of the polishing slurry comprising pyrogenic silica agglomerating or forming a sediment during storage and/or polishing, which additionally leads to a non-uniform particle size distribution. Therefore, when using the polishing slurry comprising pyrogenic silica, defects such as surface roughness and microscratches are produced on the polished semiconductor surface. The seriousness of this phenomenon increases if the line width of the IC component falls to 0.25 μm or 0.18 μm or below. Therefore, the polishing slurry belonging to the colloidal silica category is becoming increasingly widespread.

Various polishing slurries have been developed. U.S. Pat. No. 5,891,205 has disclosed a composition for a chemical-mechanical polishing slurry which comprises an alkaline, aqueous dispersion which includes particles of cerium oxide and particles of silica. U.S. Pat. No. 5,264,010 has disclosed a polishing slurry composition which includes cerium oxide, pyrogenic silica and precipitated silica. U.S. Pat. No. 5,139,571 has disclosed a polishing slurry for semiconductor wafers which includes a multiplicity of fine abrasive particles and a quaternary ammonium compound. U.S. Pat. No. 5,230,833 has disclosed a method for preparing a silica sol with a low metal content.

However, there remains a need to develop a polishing slurry of the silica sol type for chemical-mechanical polishing with a high polishing rate.

Therefore, the object of the present invention is to provide a polishing slurry for chemical-mechanical polishing with a high polishing rate and a low surface roughness of the substrate.

To achieve the above object, the polishing slurry for chemical-mechanical polishing according to the present invention contains the following components: 5 to 50% by weight of a colloidal silica abrasive, and 0.1 to 10% by weight of a quaternary ammonium salt which is represented by the formula R₄N⁺X³¹, where R may be identical or different and is selected from the group consisting of alkyl, alkenyl, alkylaryl, arylalkyl and an ester group, and X is hydroxyl or halogen.

### SUMMARY

As such, the invention relates to a polishing slurry for chemical-mechanical polishing comprising: (a) from about 5 to about 50% by weight of a colloidal silica abrasive, and (b) from about 0.1 to about 10% by weight of a quaternary ammonium salt which is represented by the formula R₄N⁺X⁻, wherein each R can be identical or different and is selected from the group consisting of alkyl, alkenyl, alkylaryl, arylalkyl and an ester groups, and wherein X is hydroxyl or halogen. These and other features, aspects, and advantages of the present invention will become better understood with reference to the following description and appended claims.

### DESCRIPTION

The polishing slurry according to the invention for chemical-mechanical polishing is particularly suitable for use in the polishing of a silica film. The silica may in this case, for example, be what is known as thermal oxide, PE-TEOS or HDP.

The silica film may contain doping elements, such as B, P and/or F.

Moreover, the polishing slurry according to the invention is suitable for polishing shaped bodies made from glass which contain SiO₂ as the principal component.

In the polishing slurry of the present invention, the colloidal silica abrasive is preferably present in a quantity of from about 10 to about 30% by weight, and the ammonium salt is preferably present in a quantity of from about 0.3 to about 5% by weight. The colloidal silica may have a mean particle size of from about 10 nm to about 1 μm, preferably from about 20 nm to about 100 nm.

The mean particle size is determined in an ultracentrifuge.

For the quaternary ammonium salt R₄N⁺X⁻ used in the invention, R may preferably be a C₁₋₂₀ alkyl, C₁₋₂₀ alkenyl, C₇₋₂₀ alkylaryl, C₇₋₂₀ arylalkyl or an ester group. The quaternary ammonium salt may simultaneously contain different radicals R. In a preferred embodiment of the present invention, X is a halogen. Particularly suitable examples for the quaternary ammonium salt are octyidimethylbenzylammonium chloride and cetyltrimethylammonium bromide.

The pH at 22° C. of the polishing slurry of the present invention may be from about 9 to about 12, preferably from about 11 to about 12.

The polishing suspension of the present invention may also contain a hydroxide of an alkali metal, such as for example potassium hydroxide.

The following examples are intended to explain the process and the advantages of the present invention more completely, without restricting the scope thereof, since numerous modifications and variations will be evident to the person skilled in the art.

### EXAMPLES

The polishing slurries of the examples and comparative examples were produced in accordance with the instructions given below. The polishing slurries were used to polish silica films on silicon wafers by means of a Westech-372 polishing machine, the films having been produced by means of a low-pressure CVD process. The results are given in Table 1. The polishing rate was calculated by dividing the difference in thickness before and after polishing by the duration of polishing, the film thickness being measured by Nanospec. The unevenness was measured by means of the 1σ method, the polishing rates being measured at 9 different positions on the wafer surface.

### EXAMPLE 1

Levasil® 50 CK/30%, a colloidal silica sol procured from Bayer AG, Leverkusen, was adjusted to 30% by weight of silica using deionized water. The mean particle size of the colloidal silica is 60 to 90 nm, and the specific surface area is 50 to 180 m²/g. 0.8% by weight of octyldimethylbenzylammonium chloride was added to the dilute silica sol and the mixture was thoroughly mixed, with the result that the desired polishing slurry, pH=11.2, was obtained. The results are given in Table 1.

### EXAMPLE 2

The same processes as in Example 1 were employed, except that the silica sol was diluted to form a polishing slurry containing 15% by weight of silica. The pH of the polishing slurry was 11.0. The results are given in Table 1.

### COMPARATIVE EXAMPLE 1

The same processes as in Example 1 were employed, except that no octyldimethylbenzylammonium chloride was added. The pH of the polishing slurry was 11.2. The results are given in Table 1.

### COMPARATIVE EXAMPLE 2

The same processes as in Example 1 were employed, except that no octyldimethylbenzylammonium chloride was added and the silica sol was diluted to a concentration of 15% by weight of silica. The pH of the polishing slurry was 11.0. The results are given in Table 1.

### COMPARATIVE EXAMPLE 3

The polishing slurry used in this example is SS 25, procured from Cabot Microelectronics, Aurora, Ill., U.S.A., containing 25% by weight of pyrogenic silica. The pH of the polishing slurry was 11.2.

### COMPARATIVE EXAMPLE 4

The SS 25 polishing suspension used in Comparative Example 3 was diluted with deionized water, with the result that the desired polishing slurry containing 12.5% by weight of pyrogenic silica and with a pH of 11.0 was obtained.

It can be seen from the above examples that the polishing rate using the polishing slurry of the colloidal silica type can be increased by adding a quaternary ammonium salt.

The above description of the preferred embodiments of this invention has been given for reasons of explanation and description. Evident modifications or variations are possible in view of the above teaching. The embodiments have been selected and described in order to offer the best illustration of the principles of this invention and its practical application and, in this way, to enable the person skilled in the art to employ the invention in various embodiments and using various modifications which are appropriate to the specific use intended. All modifications and variations lie within the scope of the present invention.

TABLE 1

| | | | Concentration | | |
|---|---|---|---|---|---|
| | | | of the | | |
| | | Silica | quaternary | Polishing | |
| | Silica | concentration | ammonium salt | rate | Unevenness |
| Examples | source | (% by weight) | (% by weight) | (Å/min) | (%) |
| Example 1 | Colloidal | 30% | 0.8% | 3100 | 4.1 |
| | silica | | | | |
| Example 2 | Colloidal | 15% | 0.8% | 2246 | 2.3 |
| | silica | | | | |
| Comp. Ex. 1 | Colloidal | 30% | 0 | 2702 | 3.9 |
| | silica | | | | |
| Comp. Ex. 2 | Colloidal | 15% | 0 | 1946 | 1.8 |
| | silica | | | | |
| Comp. Ex. 3 | Pyrogenic | 25% | 0 | 1900 | 4.1 |
| | silica | | | | |
| Comp. Ex. 4 | Pyrogenic | 12.5% | 0 | 1366 | 6 |
| | silica | | | | |

What is claimed is:

1. A polishing slurry for chemical-mechanical polishing comprising:
(a) from about 5 to about 50% by weight of a colloidal silica abrasive, and
(b) from about 0.1 to about 10% by weight of a quaternary ammonium salt which is represented by the formula R₄N⁺X⁻, wherein each R can be identical or different and is selected from the group consisting of alkyl, alkenyl, alkylaryl, arylalkyl and an ester groups, and wherein X is hydroxyl or halogen.

2. The polishing slurry according to claim 1, wherein the colloidal silica abrasive is present in a quantity ranging from about 10 to about 30% by weight, and the quaternary ammonium salt is present in a quantity ranging from about 0.3 to about 5% by weight.

3. The polishing slurry according to claim 1, wherein each R is identical or different and is a C₁₋₂₀ alkyl, a C₁₋₂₀ alkenyl, a C₇₋₂₀ alkylaryl, a C₇₋₂₀ arylalkyl or an ester group.

4. The polishing slurry according to claim 1, wherein X is a halogen.

5. The polishing slurry according to claim 4, wherein the quaternary ammonium salt is octyldimethylbenzylammonium chloride or cetyltrimethylammonium bromide.

6. The polishing slurry according to claim 5, wherein the quaternary ammonium salt is octyidimethylbenzylammonium chloride.

7. The polishing slurry according to claim 1, wherein the slurry also contains a hydroxide of an alkali metal.

8. The polishing slurry according to claim 7, wherein the hydroxide is potassium hydroxide.

9. The polishing slurry according to claim 1, wherein the slurry has a pH at 22° C. ranging from about 9 to about 12.

10. The polishing slurry according to claim 1, wherein the colloidal silica has a mean particle size ranging from about 10 nm to about 1 μm.
